(19) United States
(12) Patent Application Publication
(10) Pub. No.: US 2024/0046785 A1
(43) Pub. Date: Feb. 8, 2024

(54) SYSTEM AND METHOD FOR PREDICTING ROAD TRAFFIC SPEED

(71) Applicant: GRABTAXI HOLDINGS PTE. LTD., Singapore (SG)

(72) Inventors: Muhammad Afif Bin MOHD ALI, Singapore (SG); Suriyanarayanan VENKATESAN, Singapore (SG); Liang CHEN, Singapore (SG)

(21) Appl. No.: 18/257,672

(22) PCT Filed: Jan. 23, 2022
(86) PCT No.: PCT/SG2022/050029

§ 371 Date: Jun. 15, 2023

(30) Foreign Application Priority Data
Mar. 23, 2021 (SG) 10202102973V

(51) Int. Cl. G08G 1/052

(52) U.S. Cl. CPC G08G 1/052; G06N 3/0464

(57) ABSTRACT

A system for predicting road speed traffic is disclosed. The system may be configured to receive and process raw trajectory data to determine processed trajectory data; obtain node features representing information about road segment characteristics; obtain edge features representing information about interactions between the node features; determine a learned graph representation of a road network based on a node embedding of the node features and an edge embedding of the edge features; determine at least one hidden states value based on a graph convolution of the learned graph representation through the at least one encoder neural network; and predict road speed traffic based on the at least one hidden states value through at least one decoder neural network.

### TECHNICAL FIELD

Various aspects of this disclosure relate to a system for predicting road traffic speed. Various aspects of this disclosure relate to a method for predicting road traffic speed. Various aspects of this disclosure relate to a non-transitory computer-readable medium storing computer executable code comprising instructions for predicting road traffic speed. Various aspects of this disclosure relate to a computer executable code comprising instructions for predicting road traffic speed.

### BACKGROUND

Modernisation of societies has given rise to the need for effective urban planning. Central to modernisation is urban planning, which consists largely of road networks, hence the need for efficiency in this area. A variety of problems revolve around them—traffic congestion, travel route planning, estimating travel times, etc. Real-time road traffic speeds are strong indicators of traffic congestion, hence efficient forecasting can alleviate this problem. Travel times can also be calculated directly from speed values. Therefore, accurate speed predictions can improve overall estimated times of arrival.

Existing solutions to the speed forecasting problem can be classified into two categories—temporal approaches and spatial-temporal approaches. The first category includes methods such as historical average, Auto Regressive Integrated Moving Average (ARIMA), and support vector regression (SVR), and also deep learning networks. These methods may capture the temporal dependencies in data. Deep learning methods may also be able to capture the sequential characteristics of the data i.e. daily and periodic trends. However, road speeds are highly complex and are also dependent on spatial correlations in the network. The second category includes methods such as Spatiotemporal graph convolutional networks (STGCN) which utilises graph convolutions to account for the spatial dependencies, attention-based STGCN (ASTGCN) which incorporates the attention mechanism on top of the STGCN and ST-MGCN which uses of multiple graphs to capture non-Euclidean relationships in the road network such e.g. transport connectivity, POI attributes. However, these methods have large run time complexity and may not have accurate predications.

### SUMMARY

An advantage of the present disclosure may include improve overall estimated times of arrival by using actual, concrete topological features of the road network.

An advantage of the present disclosure may include lower run time complexity due to lower number of convolution steps which may overcome the need for multiple graph convolutions, saving time and reducing computational complexity.

An advantage of the present disclosure may include effectively capturing the spatial dependencies in the data by directly extract these features that are known to affect road traffic speeds and classify them into two classes of topological features—node features and edge features.

An advantage of the present disclosure may include more accurate speed predictions since node and edge embedding layers are done before graph convolutions and these layers attach learnable parameters to the underlying graph, allowing for the weighting factors to adapt specifically to each target node during the graph convolution operation, hence also allowing the weighting factor to adapt to larger k-hop neighbourhoods.

These and other aforementioned advantages and features of the aspects herein disclosed will be apparent through reference to the following description and the accompanying drawings. Furthermore, it is to be understood that the features of the various aspects described herein are not mutually exclusive and can exist in various combinations and permutations.

The present disclosure generally relates to system for road traffic speed. The system may include one or more processors. The system may also include a memory having instructions stored there, in the instructions, when executed by the one or more processors, may cause the one or more processors to use at least one recurrent neural network to: receive and process raw trajectory data to determine processed trajectory data; obtain node features representing information about road segment characteristics; obtain edge features representing information about interactions between the node features; determine a learned graph representation of a road network based on a node embedding of the node features and an edge embedding of the edge features; determine at least one hidden states value based on a graph convolution of the learned graph representation through the at least one encoder neural network; and predict road traffic speed based on the at least one hidden states value through at least one decoder neural network.

According to an embodiment, the raw trajectory data may include speed readings of a vehicle matched to respective road segments that the vehicle is travelling on.

According to an embodiment, the processor may be configured to process the raw trajectory data by at least one of: removing negative speed readings; aggregating the speed readings over a predetermined time interval for individual road segments; and interpolating missing speed data by linear interpolation or replacing the missing speed data with a median speed value.

According to an embodiment, the node features may be features regarding individual road segments. The edge features may be features regarding an intersection of the individual road segments.

According to an embodiment, the node features may include at least one of road class, number of lanes and length of road segments. The edge features may include at least one of Haversine distances between road segments, change in number of lanes between road segments, and change in road width between road segments.

According to an embodiment, the system may include an encoder and a decoder. The encoder may include the at least one encoder neural network. The decoder may include the at least one decoder neural network. The at least one encoder neural network may be a bidirectional neural network. The at least one decoder neural network may be a unidirectional neural network.

According to an embodiment, the processor may be configured to perform the graph convolution of the learned graph representation by using the learned graph representation and a weighing matrix.

According to an embodiment, the processor may be configured to use at least one binary adjacent matrix during the graph convolution for masking.

According to an embodiment, the at least one hidden states value may include a last hidden state value. The processor may be configured to predict road traffic speed based on the last hidden state value.

The present disclosure generally relates to a method for predicting road traffic speed. The method may include using one or more processors to: receive and process raw trajectory data to determine processed trajectory data; obtain node features representing information about road segment characteristics; obtain edge features representing information about interactions between the node features; determine a learned graph representation of a road network based on a node embedding of the node features and an edge embedding of the edge features; determine at least one hidden states value based on a graph convolution of the learned graph representation through the at least one encoder neural network; and predict road traffic speed based on the at least one hidden states value through at least one decoder neural network.

According to an embodiment, the raw trajectory data may include speed readings of a vehicle matched to respective road segments that the vehicle is travelling on.

According to an embodiment, the method may include using one or more processors to process the raw trajectory data by at least one of: removing negative speed readings; aggregating the speed readings over a predetermined time interval for individual road segments; and interpolating missing speed data by linear interpolation or replacing the missing speed data with a median speed value.

According to an embodiment, the node features may be features regarding individual road segments. The edge features may be features regarding an intersection of the individual road segments.

According to an embodiment, the node features may include at least one of road class, number of lanes and length of road segments. The edge features may include at least one of Haversine distances between road segments, change in number of lanes between road segments, and change in road width between road segments.

According to an embodiment, the at least one encoder neural network may be in an encoder. The at least one decoder neural network may be in a decoder. The at least one encoder neural network may be a bidirectional neural network. The at least one decoder neural network may be a unidirectional neural network.

According to an embodiment, the method may include using one or more processors to perform the graph convolution of the learned graph representation by using the learned graph representation and a weighing matrix.

According to an embodiment, the method may include using one or more processors to use at least one binary adjacent matrix during the graph convolution for masking.

According to an embodiment, the method may include using one or more processors to predict road traffic speed based on a last hidden state value, wherein the at least one hidden states value comprises the last hidden state value.

The present disclosure generally relates to a non-transitory computer-readable medium storing computer executable code comprising instructions for predicting road traffic speed according to the present disclosure.

The present disclosure generally relates to a computer executable code comprising instructions for predicting road traffic speed according to the present disclosure.

To the accomplishment of the foregoing and related ends, the one or more embodiments include the features hereinafter fully described and particularly pointed out in the claims. The following description and the associated drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

In the drawings, like reference characters generally refer to the same parts throughout the different views. The drawings are not necessarily to scale, emphasis instead generally being placed upon illustrating the principles of the present disclosure. The dimensions of the various features or elements may be arbitrarily expanded or reduced for clarity. In the following description, various aspects of the present disclosure are described with reference to the following drawings, in which:

FIG. 1 illustrates a schematic diagram of a system according to an embodiment of the present disclosure.

FIG. 2 shows a flowchart of a method according to various embodiments.

FIG. 3 shows a flow diagram of a method according to various embodiments.

FIG. 4 illustrates a schematic diagram of an exemplary edge embedding according to various embodiments.

FIG. 5 shows a flow diagram of a system including an encoder-decoder according to various embodiments.

FIG. 6 shows a flow diagram of a convolution layer according to various embodiments.

### DETAILED DESCRIPTION

The following detailed description refers to the accompanying drawings that show, by way of illustration, specific details and embodiments in which the invention may be practiced. These embodiments are described in sufficient detail to enable those skilled in the art to practice the invention. Other embodiments may be utilized and structural, and logical changes may be made without departing from the scope of the invention. The various embodiments are not necessarily mutually exclusive, as some embodiments can be combined with one or more other embodiments to form new embodiments.

Embodiments described in the context of one of the systems or server or methods or computer program are analogously valid for the other systems or server or methods or computer program and vice-versa.

Features that are described in the context of an embodiment may correspondingly be applicable to the same or similar features in the other embodiments. Features that are described in the context of an embodiment may correspondingly be applicable to the other embodiments, even if not explicitly described in these other embodiments. Furthermore, additions and/or combinations and/or alternatives as described for a feature in the context of an embodiment may correspondingly be applicable to the same or similar feature in the other embodiments.

The word “exemplary” is used herein to mean “serving as an example, instance, or illustration.” Any embodiment or design described herein as “exemplary” is not necessarily to be construed as preferred or advantageous over other embodiments or designs

In the context of various embodiments, the articles “a”, “an”, and “the” as used with regard to a feature or element include a reference to one or more of the features or elements.

As used herein, the term “and/or” includes any and all combinations of one or more of the associated listed items.

The terms “at least one” and “one or more” may be understood to include a numerical quantity greater than or equal to one (e.g., one, two, three, four, [ . . . ], etc.). The term “a plurality” may be understood to include a numerical quantity greater than or equal to two (e.g., two, three, four, five, [ . . . ], etc.).

The words “plural” and “multiple” in the description and the claims expressly refer to a quantity greater than one. Accordingly, any phrases explicitly invoking the aforementioned words (e.g. “a plurality of [objects]”, “multiple [objects]”) referring to a quantity of objects expressly refers more than one of the said objects. The terms “group (of)”, “set [of]”, “collection (of)”, “series (of)”, “sequence (of)”, “grouping (of)”, etc., and the like in the description and in the claims, if any, refer to a quantity equal to or greater than one, i.e. one or more. The terms “proper subset”, “reduced subset”, and “lesser subset” refer to a subset of a set that is not equal to the set, i.e. a subset of a set that contains less elements than the set.

The term “data” as used herein may be understood to include information in any suitable analog or digital form, e.g., provided as a file, a portion of a file, a set of files, a signal or stream, a portion of a signal or stream, a set of signals or streams, and the like. Further, the term “data” may also be used to mean a reference to information, e.g., in form of a pointer. The term data, however, is not limited to the aforementioned examples and may take various forms and represent any information as understood in the art.

The term “processor” or “controller” as, for example, used herein may be understood as any kind of entity that allows handling data, signals, etc. The data, signals, etc. may be handled according to one or more specific functions executed by the processor or controller.

A processor or a controller may thus be or include an analog circuit, digital circuit, mixed-signal circuit, logic circuit, processor, microprocessor, Central Processing Unit (CPU), Graphics Processing Unit (GPU), Digital Signal Processor (DSP), Field Programmable Gate Array (FPGA), integrated circuit, Application Specific Integrated Circuit (ASIC), etc., or any combination thereof. Any other kind of implementation of the respective functions, which will be described below in further detail, may also be understood as a processor, controller, or logic circuit. It is understood that any two (or more) of the processors, controllers, or logic circuits detailed herein may be realized as a single entity with equivalent functionality or the like, and conversely that any single processor, controller, or logic circuit detailed herein may be realized as two (or more) separate entities with equivalent functionality or the like.

The term “system” (e.g., a drive system, a position detection system, etc.) detailed herein may be understood as a set of interacting elements, the elements may be, by way of example and not of limitation, one or more mechanical components, one or more electrical components, one or more instructions (e.g., encoded in storage media), one or more controllers, etc.

A “circuit” as user herein is understood as any kind of logic-implementing entity, which may include special-purpose hardware or a processor executing software. A circuit may thus be an analog circuit, digital circuit, mixed-signal circuit, logic circuit, processor, microprocessor, Central Processing Unit (“CPU”), Graphics Processing Unit (“GPU”), Digital Signal Processor (“DSP”), Field Programmable Gate Array (“FPGA”), integrated circuit, Application Specific Integrated Circuit (“ASIC”), etc., or any combination thereof. Any other kind of implementation of the respective functions which will be described below in further detail may also be understood as a “circuit.” It is understood that any two (or more) of the circuits detailed herein may be realized as a single circuit with substantially equivalent functionality, and conversely that any single circuit detailed herein may be realized as two (or more) separate circuits with substantially equivalent functionality. Additionally, references to a “circuit” may refer to two or more circuits that collectively form a single circuit.

As used herein, “memory” may be understood as a non-transitory computer-readable medium in which data or information can be stored for retrieval. References to “memory” included herein may thus be understood as referring to volatile or non-volatile memory, including random access memory (“RAM”), read-only memory (“ROM”), flash memory, solid-state storage, magnetic tape, hard disk drive, optical drive, etc., or any combination thereof. Furthermore, it is appreciated that registers, shift registers, processor registers, data buffers, etc., are also embraced herein by the term memory. It is appreciated that a single component referred to as “memory” or “a memory” may be composed of more than one different type of memory, and thus may refer to a collective component including one or more types of memory. It is readily understood that any single memory component may be separated into multiple collectively equivalent memory components, and vice versa. Furthermore, while memory may be depicted as separate from one or more other components (such as in the drawings), it is understood that memory may be integrated within another component, such as on a common integrated chip.

The following detailed description refers to the accompanying drawings that show, by way of illustration, specific details and aspects in which the present disclosure may be practiced. These aspects are described in sufficient detail to enable those skilled in the art to practice the present disclosure. Various aspects are provided for the present system, and various aspects are provided for the methods. It will be understood that the basic properties of the system also hold for the methods and vice versa. Other aspects may be utilized and structural, and logical changes may be made without departing from the scope of the present disclosure. The various aspects are not necessarily mutually exclusive, as some aspects can be combined with one or more other aspects to form new aspects.

To more readily understand and put into practical effect, the present system, method, and other particular aspects will now be described by way of examples and not limitations, and with reference to the figures. For the sake of brevity, duplicate descriptions of features and properties may be omitted.

It will be understood that any property described herein for a specific system or device may also hold for any system or device described herein. It will also be understood that any property described herein for a specific method may hold for any of the methods described herein. Furthermore, it will be understood that for any device, system, or method described herein, not necessarily all the components or operations described will be enclosed in the device, system, or method, but only some (but not all) components or operations may be enclosed.

The term “comprising” shall be understood to have a broad meaning similar to the term “including” and will be understood to imply the inclusion of a stated integer or operation or group of integers or operations but not the exclusion of any other integer or operation or group of integers or operations. This definition also applies to variations on the term “comprising” such as “comprise” and “comprises”.

The term “coupled” (or “connected”) herein may be understood as electrically coupled or as mechanically coupled, e.g., attached or fixed or attached, or just in contact without any fixation, and it will be understood that both direct coupling or indirect coupling (in other words: coupling without direct contact) may be provided.

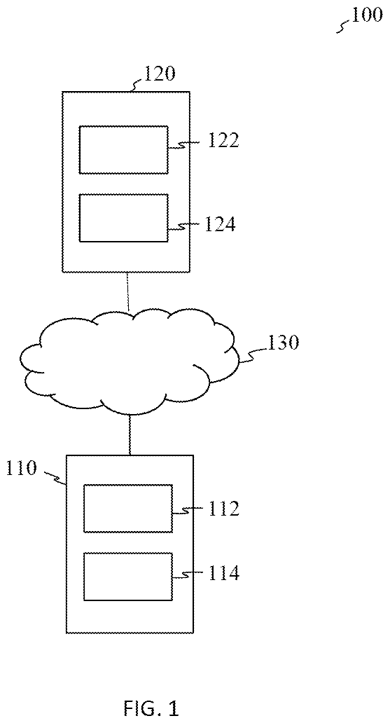

FIG. 1 illustrates a schematic diagram of a system according to an embodiment of the present disclosure.

According to various embodiments, the system 100 may be used for predicting road traffic speed. In various embodiments, the system 100 may include a server 110, and/or a user device 120.

In various embodiments, the server 110 and the user device 120 may be in communication with each other through communication network 130. In an embodiment, even though FIG. 1 shows a line connecting the server 110 to the communication network 130, a line connecting the user device 120 to the communication network 130, the server 110, and the user device 120 may not be physically connected to each other, for example through a cable. In an embodiment, the server 110, and the user device 120 may be able to communicate wirelessly through communication network 130 by internet communication protocols or through a mobile cellular communication network.

In various embodiments, the server 110 may be a single server as illustrated schematically in FIG. 1, or have the functionality performed by the server 110 distributed across multiple server components. In an embodiment, The server 110 may include one or more server processor(s) 112. In an embodiment, the various functions performed by the server 110 may be carried out across the one or more server processor(s). In an embodiment, each specific function of the various functions performed by the server 110 may be carried out by specific server processor(s) of the one or more server processor(s).

In an embodiment, the server 110 may include a memory 114. In an embodiment, the server 110 may also include a database. In an embodiment, the memory 114 and the database may be one component or may be separate components. In an embodiment, the memory 114 of the server may include computer executable code defining the functionality that the server 110 carries out under control of the one or more server processor 112.

In an embodiment, the database and/or memory 114 may include historical data of past transportation services, e.g., road traffic speeds, road segments, and time. The historical data may include road traffic speeds on each road segment at each specific time. The road traffic speed may be obtain every 1 second. In an embodiment, the memory 114 may include or may be a computer program product such as a non-transitory computer-readable medium.

According to various embodiments, a computer program product may store the computer executable code including instructions for predicting road traffic speed according to the various embodiments. In an embodiment, the computer executable code may be a computer program. In an embodiment, the computer program product may be a non-transitory computer-readable medium. In an embodiment, the computer program product may be in the system 100 and/or the server 110.

In some embodiments, the server 110 may also include an input and/or output module allowing the server 110 to communicate over the communication network 130. In an embodiment, the server 110 may also include a user interface for user control of the server 110. In an embodiment, the user interface may include, for example, computing peripheral devices such as display monitors, user input devices, for example, touchscreen devices and computer keyboards.

In an embodiment, the user device 120 may include a user device memory 122. In an embodiment, the user device 120 may include a user device processor 124. In an embodiment, the user device memory 122 may include computer executable code defining the functionality the user device 120 carries out under control of the user device processor 124. In an embodiment, the user device memory 122 may include or may be a computer program product such as a non-transitory computer-readable medium.

In an embodiment, the user device 120 may also include an input and/or output module allowing the user device 120 to communicate over the communication network 130. In an embodiment, the user device 120 may also include a user interface for the user to control the user device 120. In an embodiment, the user interface may be a touch panel display. In an embodiment, the user interface may include a display monitor, a keyboard or buttons.

In an embodiment, the system 100 may be used for predicting road traffic speed. In an embodiment, the memory 114 may have instructions stored therein. In an embodiment, the instructions, when executed by the one or more processors may cause the processor 112 to use at least one neural network to predict road traffic speed.

In an embodiment, a single pass of the neural network may entail passing the data first through the encoder, followed by the decoder.

In an embodiment, in the encoder, the node and edge features may be first passed through the node embedding and edge embedding layers respectively. Each layer may learn a non-linear representation of the raw features, which may be fused together via an element-wise multiplication. The fused representation may be regarded as a latent feature representation of the underlying road network, and may be used in the graph convolution layer to learn the spatial relationships in the data. A masking operation may also done following the graph convolution to restrict the receptive field of the graph convolution to only its immediate neighbours. The output of the graph convolution layer may then passed into a bi-directional GRU to learn the temporal relationships in the data. The outputs of the bi-directional GRU may regarded as the final output of the encoder.

Subsequently, the output of the encoder may passed into the decoder, which may include a uni-directional GRU to perform the simultaneous, multiple horizon forecasting in a single pass. The output of the decoder may be the predicted speeds.

In an embodiment, the processor 112 may obtain receive raw trajectory data. In an embodiment, the raw trajectory data may include historical data of past transportation services, e.g., road traffic speeds, road segments, and time. In an embodiment, the historical data may include road traffic speeds on each road segment at each specific time. In an embodiment, the raw trajectory data may include speed readings of a vehicle matched to respective road segments that the vehicle is travelling on.

In an embodiment, the processor 112 may process the raw trajectory data. In an embodiment, the processor may be configured to process the raw trajectory data by removing negative speed readings. In an embodiment, the processor 112 may be configured to process the raw trajectory data by aggregating the speed readings over a predetermined time interval for individual road segments. In an embodiment, the predetermined time interval may be between 3-7 minutes, e.g, 5 minutes.

In an embodiment, the processor 112 may be configured to process the raw trajectory data by interpolating missing speed data by linear interpolation. In an embodiment, the processor 112 may be configured to process the raw trajectory data by replacing the missing speed data with a median speed value. In an embodiment, the median speed value may be different for each individual road. The median speed value may also be different during different times of the day.

In an embodiment, the processor 112 may be configured to process the raw trajectory data to determine a processed trajectory data.

In an embodiment, the processor 112 may obtain node features. The node features may represent information about road segment characteristics. In an embodiment, the node features may be features regarding individual road segments. In an embodiment, the node features may include at least one of road class, number of lanes and length of road segments. The road class may include information such as the speed limit of the road.

In an embodiment, the processor 112 may perform a node embedding on the node features.

In an embodiment, the processor 112 may obtain edge features. The edge features may represent information about interactions between the node features. In an embodiment, the edge features may be features regarding an intersection of the individual road segments. In an embodiment, the edge features may include at least one of Haversine distances between road segments, change in number of lanes between road segments, and change in road width between road segments. In an embodiment, the at least one of Haversine distances between road segments may be the great-circle distance between two points on a sphere given their longitudes and latitudes

In an embodiment, the processor 112 may perform an edge embedding on the edge features.

In an embodiment, the processor 112 may determine a learned graph representation of a road network based on the node embedding of the node features and the edge embedding of the edge features. In an embodiment, the at least one encoder neural network may be a recurrent neural network (RNN), such as a Long short-term memory (LSTM) or a Gated Recurrent Unit (GRU).

In an embodiment, the processor 112 may perform a graph convolution on the learned graph representation. In an embodiment, the processor 112 may be configured to perform the graph convolution by using the learned graph representation and a weighing matrix. In an embodiment, the processor 112 may be configured to perform the graph convolution by also using the processed trajectory data.

In an embodiment, the processor 112 may be configured to use at least one binary adjacent matrix during the graph convolution for masking. In an embodiment, the masking may filter or may handle unwanted, missing, or invalid data during the graph convolution.

In an embodiment, the processor 112 may determine at least one hidden states value based on the graph convolution of the learned graph representation through the at least one encoder neural network. In an embodiment, a result of the graph convolution may be passed through the at least one encoder neural network to obtain the at least one hidden states value.

In an embodiment, the processor 112 may perform a 2 layer graph convolution. In an embodiment, a first result of a first graph convolution may be passed through the at least one encoder neural network to obtain a second result. In an embodiment, the second result may be passed through a second graph convolution to obtain a third result. In an embodiment, the third result may be through the at least one encoder neural network to obtain at least one hidden states value.

In an embodiment, the processor 112 may predict road traffic speed based on the at least one hidden states value through at least one decoder neural network. In an embodiment, the at least one decoder neural network may be a recurrent neural network (RNN), such as a Long short-term memory (LSTM) or a Gated Recurrent Unit (GRU).

In an embodiment, the at least one hidden states value may include a last hidden state value. In an embodiment, the processor 112 may be configured to predict road traffic speed based on the last hidden state value.

In an embodiment, the system 100 may include an encoder. In an embodiment, the processor 112 may be a part of or may be controlled by the encoder. In an embodiment, the encoder may include the at least one encoder neural network. In an embodiment, the encoder may be a bidirectional neural network.

In an embodiment, the system 100 may include an decoder. In an embodiment, the processor 112 may be a part of or may be controlled by the decoder. In an embodiment, the decoder may include the at least one decoder neural network. In an embodiment, the decoder may be a unidirectional neural network.

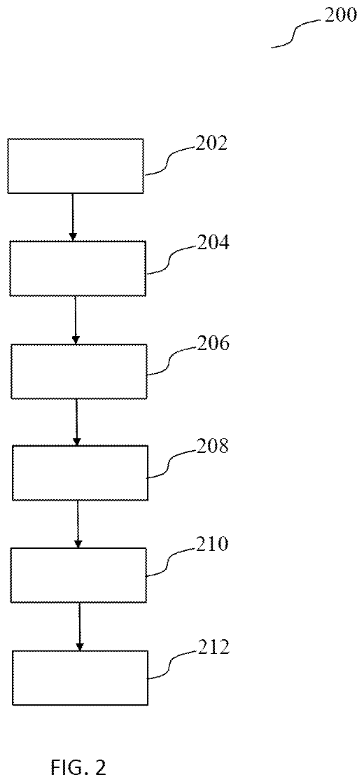

FIG. 2 shows a flowchart of a method according to various embodiments.

According to various embodiments, the method 200 for predicting road traffic speed may be provided. In an embodiment, the method 200 may include a step 202 of using one or more processors to obtain receive and process raw trajectory data to determine processed trajectory data.

In an embodiment, the method 200 may include a step 204 of using one or more processors to obtain node features representing information about road segment characteristics.

In an embodiment, the method 200 may include a step 206 of using one or more processors to obtain edge features representing information about interactions between the node features.

In an embodiment, the method 200 may include a step 208 of using one or more processors to determine a learned graph representation of a road network based on a node embedding of the node features and to determine an edge embedding of the edge features through at least one encoder neural network.

In an embodiment, the method 200 may include a step 210 of using one or more processors to determine at least one hidden states value based on a graph convolution of the learned graph representation through the at least one encoder neural network.

In an embodiment, the method 200 may include a step 212 of using one or more processors to predict road traffic speed based on the at least one hidden states value through at least one decoder neural network.

In an embodiment, steps 202 to 212 are shown in a specific order, however other arrangements are possible. Steps may also be combined in some cases. Any suitable order of steps 202 to 212 may be used.

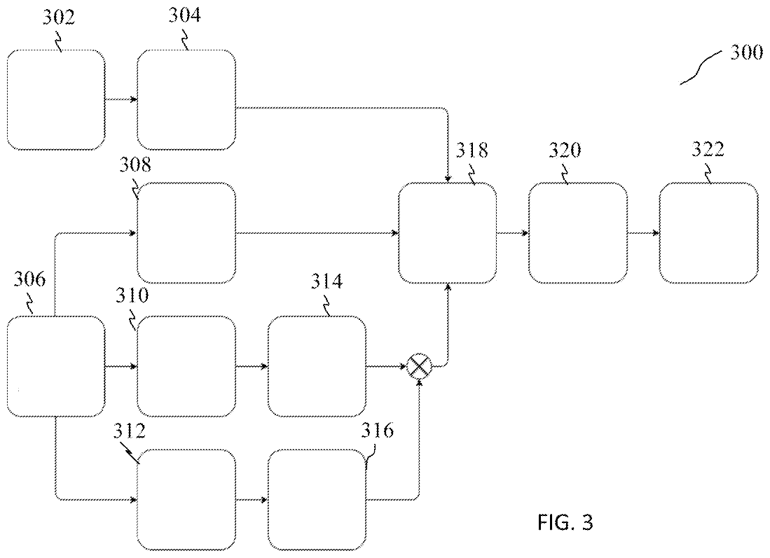

FIG. 3 shows a flow diagram of a method according to various embodiments.

According to various embodiments, the flow diagram 300 for predicting road traffic speed may be provided. In an embodiment, the flow diagram 300 may include a step 302 of collecting raw trajectory data. In an embodiment, the raw trajectory data may be collected from completed trips. In an embodiment, the raw trajectory data may may include speed readings at the given time on a predetermined time interval, e.g., a 1-second interval, for the entire trip. In an embodiment, the data may be map-matched to the respective road segments that the vehicle is travelling on.

In an embodiment, the flow diagram 300 may include a step 304 of processing the raw trajectory data. In an embodiment, the negative speed readings may be removed. In an embodiment, the speed readings may be aggregated over a predetermined time interval, e.g., minutes intervals, for individual road segments. In an embodiment, the speed reading may be aggregated based on time periods for each road. In an embodiment, associated trajectory IDs associated with the speed readings may not need to be used for future calculations. In an embodiment, there may be periods with “block” missing data e.g., 30 minutes missing, which may be due to no drivers travelling over the road segment. In an embodiment, the missing value imputation may be interpolated by applying linear interpolation. In an embodiment, the missing value imputation may replaced with road class speed median values. In an embodiment, the median speed value may be different for each individual road. The median speed value may also be different during different times of the day.

In an embodiment, the flow diagram 300 may include a step 306 of obtaining a road network structure from internal map data. In an embodiment, the internal map data may be based on OpenStreetMaps (OSM). In an embodiment, each road segment may be identified using a unique OSM way ID and/or a pair of OSM start and end node IDs.

In an embodiment, the flow diagram 300 may include a step 308 of obtaining at least one adjacency matrix. In an embodiment, the at least one adjacency matrix may be binary adjacency matrix. In an embodiment, the incoming and outgoing adjacency matrices may be constructed to represent the graph structure. In an embodiment, individual road segments may be regarded as nodes. In an embodiment junctions and/or intersections may be regarded as edges.

In an embodiment, the flow diagram 300 may include a step 310 of determining node level features. In an embodiment, the node level features may be extracted from the road network. In an embodiment, the node level features may describe a particular road segment i.e. road segment characteristics and/or attributes. In an embodiment, the node level features may refer to road class, and/or number of lanes, and/or length of individual road segments.

In an embodiment, the flow diagram 300 may include a step 312 of determining edge level features. In an embodiment, the edge level features may be engineered directly from the road network and/or from the node level features. In an embodiment, the edge level features may describe interactions between node pairings i.e. relationships between to road segments. In an embodiment, the edge level features may include Haversine distances, and/or change in the number of lanes, and/or change in road width.

In an embodiment, the flow diagram 300 may include a step 314 of performing node embedding on the node features. This step may be referred to as the node embedding layer. In an embodiment, the purpose of the node embedding layer may be to obtain non-linear mappings of the road segment attributes for use in the network. In an embodiment, the node embedding layer may aim at learning non-linear mappings, for example through the use of a 2-layered fully connected network. In an embodiment, the 2-layered fully connected network may have a rectified linear (ReLU) activation function in between. In an embodiment, the node features may be trained together with the speed readings in a graph convolution layer. In an embodiment, the node features may be trained separate from the speed readings in the graph convolution layer to focus on capturing the spatial aspect of the node features.

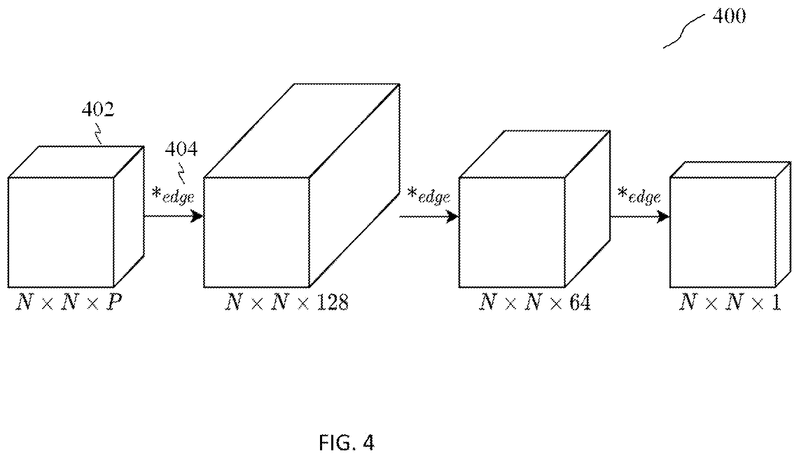

In an embodiment, the flow diagram 300 may include a step 316 of performing edge embedding on the edge features. In an embodiment, the purpose of the edge embedding layer may be to obtain non-linear mappings of the interactions between node pairings. Further details on edge embedding may be made with reference to FIG. 4.

FIG. 4 illustrates a schematic diagram of an exemplary edge embedding 400 according to various embodiments.

In the example of FIG. 4, the edge features 402 may be convoluted using an edge embedding operation 404*_{edge}. In an embodiment, the edge features may be learned through a 3-layered 1×1 embedding (i.e., convolutional) network. In an embodiment, the embedding network may have a LeakyReLU activation function with a decay rate of 0.1. In an embodiment, 1×1 embedding network may be used as a means for dimensionality reduction and reducing computational complexity. In an embodiment, 1×1 embedding network may be used to replicate the effects of a fully connected layer on but with 3D inputs. In an embodiment, following the embedding, the diagonal elements of the matrix may be replaced with 1. In an embodiment, since the diagonal elements may indicate interactions between the same node i.e. node i and node I, by replacing the diagonal elements of the matrix with 1 may ensure that the target node's features are not ignored during the graph convolution layer.

Returning back to FIG. 3, after step 316 of performing edge embedding, the learned mappings of the node embedding and the edge embedding may be fused using element-wise multiplication of learned node vectors along the rows of the learned edge matrix, for example a Hadamard product. In an embodiment, the final result of the multiplication may be the learned graph representation of the underlying road network for use in graph convolution.

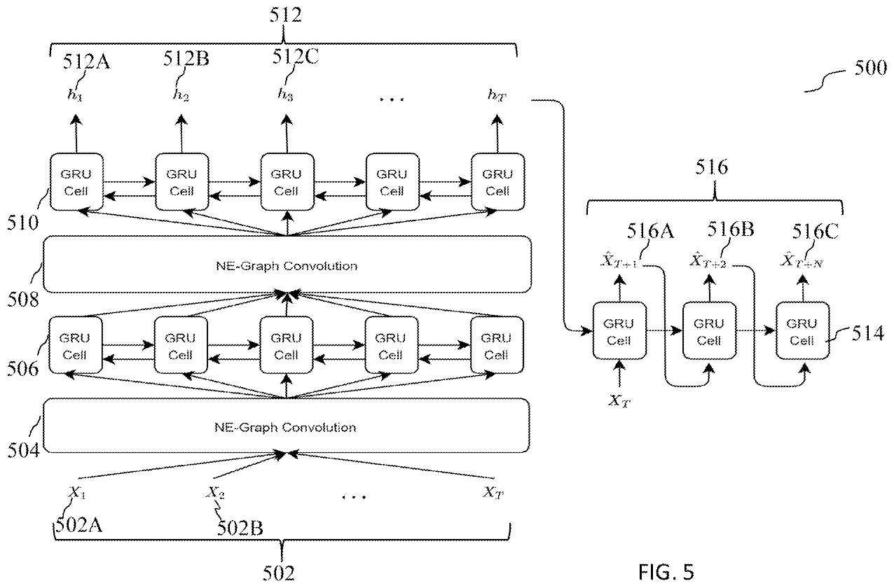

In an embodiment, the flow diagram 300 may include a step 318 of performing graph convolution. In an embodiment, a 2 layer graph convolution may be performed. Further details on graph convolution may be made with reference to FIG. 5.

FIG. 5 shows a flow diagram of a system including an encoder-decoder according to various embodiments.

The encoder-decoder structure of the network may decrease computational time as it allows for forecasting of multiple time horizon in a single pass. Without this structure, forecasting on multiple time steps may have to be done iteratively, one after another.

For example, suppose at time T, we use N historical time steps to predict K future time steps i.e. (T+1), (T+2), . . . , (T+K). A typical network may first use the (T−N) to T time steps to forecast (T+1). The next step may then use (T−N+1) to T and the predicted (T+1) time steps to forecast (T+2). This may be done iteratively until all K time steps have been forecasted. However, using the encoder-decoder structure, all K time steps may be forecasted in a single pass without the need for the iterative process, hence reducing the overall computational time taken and improving the efficiency of the network.

In an example of FIG. 5, to perform graph convolution, an encoder-decoder structure may be used. The encoder-decoder structure may include neural networks such as a RNN, LSTM and GRU. In the example of FIG. 5, GRU is used, but any other suitable neural network may be used. GRU may be used to perform r time series long term forecasting. The GRU may be an improvement to LSTM and may be capable of capturing long-term dependencies in the data but with improved computational efficiency through the maintenance of a hidden state vector as compared to an LSTM. This may be because the GRU calculates one less gate, only using two gates, a reset gate and an update gate.

In an embodiment, the GRU may be represented by the following equations:

rₜ=σ(Wᵢᵣxₜ+bᵢᵣ+Wₕᵣhₜ₋₁+bₕᵣ)

zₜ=σ(W_{iz}xₜ+b_{iz}+W_{hz}hₜ₋₁b_{hz})

\tilde{h}ₜ=tanh(Wᵢₕxₜ+bᵢₕ+rₜ⊙(Wₕₕhₜ₋₁+bₕₕ))

hₜ=(1−zₜ)⊙\tilde{h}ₜ+zₜ⊙h₍ₜ₋₁₎

In the equations, r may represent the reset gates, z may represent the update gates, \tilde{h} may represent hidden state update values, hₜ may represents the hidden state at time t, xₜ may represent the inputs at time t, ⊙ may represent the Hadamard product, Wᵢ, bᵢ may represent weights and biases associated with inputs, and Wₕ, bₕ may represent weights and biases associated with hidden states.

In an embodiment the encoder-decoder structure may combine two GRUs—an encoder GRU and a decoder GRU. In an embodiment, the bridge combining the two may be the last hidden state of the encoder GRU. In an embodiment, a bidirectional GRU is used for the encoder. In an embodiment, a unidirectional GRU is used for the decoder. In an embodiment, the bidirectional encoder GRU may outputs hᵢ=[hᵢ^{forward}, hᵢ^{backward}], which may be combined using element-wise addition.

In the example of FIG. 5, a trajectory data 502 may include a first trajectory data 502A and/or a second trajectory data 502B. In an embodiment, the trajectory data 502 may pass through a first node embedding, a first edge embedding and a first graph convolution which may be shorten to a first NE-graph convolution 504 to obtain a first result. The first result may be passed through at least one encoder neural network 506 to obtain a second result. The second result may pass through a second NE-graph convolution 508 to obtain a third result. The third result may be passed through at least one encoder neural network 510 to obtain at least one hidden state 512. The at least one encoder neural network 506 may be the at least one encoder neural network 510.

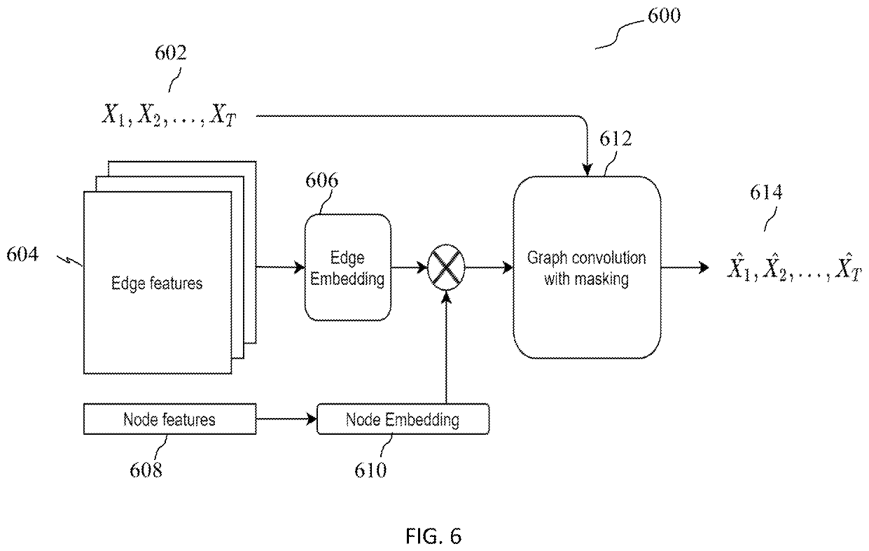

Further details on graph convolution may be made with reference to FIG. 6.

FIG. 6 shows a flow diagram 600 of a convolution layer according to various embodiments.

In an embodiment, a convolution layer i.e., node-edge graph convolution layer may be made up of the node embedding, edge embedding and graph convolution layers. In an embodiment, mathematically, graph convolutions may be defined as

$$f ( {H}^{( l )} , A ) = σ ( {\hat{D}}^{\frac{1}{2}} \hat{A} {\hat{D}}^{- \frac{1}{2}} {H}^{( l )} {W}^{( l )} ) ,$$

where σ may represent the activation function, \hat{D} may represent the diagonal node degree matrix, Â may represent the adjacency matrix, H^{(l)} may be the inputs from layer 1 and W^{(l)} may be the weights matrix for layer 1. In an embodiment,

$${\hat{D}}^{\frac{1}{2}} \hat{A} {\hat{D}}^{- \frac{1}{2}}$$

may be also known as the symmetric normalised graph Laplacian.
In an embodiment, the graph convolutions may be rewritten in vector form as

$${h}_{{v}_{i}}^{( l + 1 )} = σ ( {\sum }_{j ∈ {N}_{i}} \frac{1}{{c}_{ij}} {h}_{{v}_{j}}^{( l )} {W}^{( l )} ) ,$$

where hᵥ_{ᵢ}^{(l+1)} may represent the features for layer (l+1) of node

$${v}_{i} , \frac{1}{{c}_{ij}}$$

may represent the normalisation factor of nodes vᵢ and vⱼ derived from the graph Laplacian, and Nᵢ may represent the neighbours of the target node i. The top of the summation sign is meant to be empty as the condition on the bottom disallows for a single upper limit value of the summation to be defined i.e. the upper limit varies with different values of j.

In an embodiment, in vector form, the normalisation factor may be regarded as a weight i.e. weighting factor to the graph convolution operation which may be explicitly defined by the graph Laplacian. In an embodiment, the weighting factor may be defined implicitly i.e. learned together with the entire network through the use of node and edge embedding layers.

In an embodiment, topographically enhanced (TOP-EN) graph convolution may be performed using the input speeds, learned graph representation, and a weight matrix.

In an embodiment, at least one adjacency matrix, e.g., a binary 0-1 adjacency matrix, may be used for masking. The masking may be to restrict the receptive field to immediate neighbours. More layers may be stacked to expand the receptive field. In an embodiment, both incoming and outgoing matrices may be used for separate graph convolutions to account for the direction of travel and fused using an element-wise multiplication.

In an embodiment, 2 layers of encoder GRU and node-edge graph convolution are used, where they alternate between one another.

In an example of FIG. 6, the edge features 604 may undergo edge embedding 606. The node features 608 may undergo node embedding 610. In an embodiment, the processed trajectory data 602, the edge embedding 606 and the node embedding 610 may be used to obtain learned graph representation of the underlying road network. The learned graph representation may be used in graph convolution 612. Masking may also be used during graph convolution 612. In an embodiment, road traffic speeds 614 may be predicted based on the graph convolution 612.

Returning back to FIG. 3, after step 318 of performing graph convolution, a step 320 of passing the hidden states to a decoder may be performed.

Referring back to FIG. 5, the at least one hidden state 512 may be passed to a decoder. In an embodiment, the at least one hidden state 512 may include a first hidden state 512A, a second hidden state 512B, a third hidden state 512C, and/or a last hidden state h T. In an embodiment, the last hidden state h T may be passed to a neural network 514 of the decoder.

Returning to FIG. 3, after step 320 of passing the hidden states to a decoder, a step 322 of predicting a road traffic speed may be performed.

Referring back to FIG. 5, since the last hidden state h T has been passed through all the neural network 514 cells, the neural network 514 cells may maintain information of all the previous time steps i.e. long term dependencies. Hence, the last hidden state h T may be used as the initial hidden state for the decoder to preserve the temporal correlations as multi-step predictions may be performed. In an embodiment, the decoder may use the last hidden state h T to predict road traffic speeds 516. In an embodiment, the decoder may use a speed at time T to predict future road traffic speeds 516. The road traffic speeds may include a first predication 516A at time T+1, and/or a second predication 516B at time T+2, and/or a third predication 516C at time T+3, and/or a N predication 516D at time T+N.

The result i.e., the predicted speeds, are shown to be of state-of-the-art standards, achieving metrics comparable to that of state-of-the-art methods in the domain. The speeds may be incorporated into online mapping platforms to provide accurate readings of the speeds on any road, possibly more accurate than the existing method in use. If necessary, they may also be used for downstream tasks such as providing travel time estimations, subjected to further processing.

From speed prediction tasks, the system disclosed herein may be extended for other use cases such as travel time estimation and route planning. Alternatively, the node-edge graph convolution component may also be used in various domains that involve graphs. Examples may include social networks and knowledge graphs, or even biological fields such as the study of protein-protein interactions.

While the present disclosure has been particularly shown and described with reference to specific aspects, it should be understood by those skilled in the art that various changes in form and detail may be made therein without departing from the scope of the present disclosure as defined by the appended claims. The scope of the present disclosure is thus indicated by the appended claims and all changes which come within the meaning and range of equivalency of the claims are therefore intended to be embraced.

What is claimed is:

1. A system for predicting road traffic speed comprising:
one or more processors; and
a memory having instructions stored therein, the instructions, when executed by the one or more processors, causing the one or more processors to:
receive and process raw trajectory data to determine processed trajectory data;
obtain node features representing information about road segment characteristics;
obtain edge features representing information about interactions between the node features;
determine a learned graph representation of a road network based on a node embedding of the node features and an edge embedding of the edge features;
determine at least one hidden states value based on a graph convolution of the learned graph representation through the at least one encoder neural network; and
predict road traffic speed based on the at least one hidden states value through at least one decoder neural network.

2. The system of claim 1, wherein the raw trajectory data comprises speed readings of a vehicle matched to respective road segments that the vehicle is travelling on.

3. The system of claim 2, wherein the processor is configured to process the raw trajectory data by at least one of:
removing negative speed readings;
aggregating the speed readings over a predetermined time interval for individual road segments; and
interpolating missing speed data by linear interpolation or replacing the missing speed data with a median speed value.

4. The system of claim 1, wherein the node features are features regarding individual road segments, and the edge features are features regarding an intersection of the individual road segments.

5. The system of claim 1, wherein the node features comprise at least one of road class, number of lanes and length of road segments, and wherein the edge features comprise at least one of Haversine distances between road segments, change in number of lanes between road segments, and change in road width between road segments.

6. The system of claim 1, further comprising an encoder and a decoder; wherein the encoder comprises the at least one encoder neural network and the decoder comprises the at least one decoder neural network; and
wherein the at least one encoder neural network is a bidirectional neural network, and the at least one decoder neural network is a unidirectional neural network.

7. The system of claim 1, wherein the processor is configured to perform the graph convolution of the learned graph representation by using the learned graph representation and a weighing matrix.

8. The system of claim 1, wherein the processor is configured to use at least one binary adjacent matrix during the graph convolution for masking.

9. The system of claim 1, wherein the at least one hidden states value comprises a last hidden state value, and the processor is configured to predict road traffic speed based on the last hidden state value.

10. A method for predicting road traffic speed comprising:
using one or more processors to:
receive and process raw trajectory data to determine processed trajectory data;
obtain node features representing information about road segment characteristics;
obtain edge features representing information about interactions between the node features;
determine a learned graph representation of a road network based on a node embedding of the node features and an edge embedding of the edge;
determine at least one hidden states value based on a graph convolution of the learned graph representation through the at least one encoder neural network; and
predict road traffic speed based on the at least one hidden states value through at least one decoder neural network.

11. The method of claim 10, wherein the raw trajectory data comprises speed readings of a vehicle matched to respective road segments that the vehicle is travelling on.

12. The method of claim 10, further comprising using one or more processors to process the raw trajectory data by at least one of:
removing negative speed readings;
aggregating the speed readings over a predetermined time interval for individual road segments; and
interpolating missing speed data by linear interpolation or replacing the missing speed data with a median speed value.

13. The method of claim 10, wherein the node features are features regarding individual road segments, and the edge features are features regarding an intersection of the individual road segments.

14. The method of claim 10, wherein the node features comprise at least one of road class, number of lanes and length of road segments, and wherein the edge features comprise at least one of Haversine distances between road segments, change in number of lanes between road segments, and change in road width between road segments.

15. The method of claim 10, wherein the at least one encoder neural network is in an encoder, and the at least one decoder neural network is in a decoder, and wherein the at least one encoder neural network is a bidirectional neural network, and the at least one decoder neural network is a unidirectional neural network.

16. The method of claim 10, further comprising using one or more processors to perform the graph convolution of the learned graph representation by using the learned graph representation and a weighing matrix.

17. The method of claim 10, further comprising using one or more processors to use at least one binary adjacent matrix during the graph convolution for masking.

18. The method of claim 10, further comprising using one or more processors to predict road traffic speed based on a last hidden state value, wherein the at least one hidden states value comprises the last hidden state value.

19. A non-transitory computer-readable medium storing computer executable code comprising instructions for predicting road traffic speed according to a method for predicting road traffic speed comprising:
using one or more processors to:
receive and process raw trajectory data to determine processed trajectory data;
obtain node features representing information about road segment characteristics;
obtain edge features representing information about interactions between the node features;
determine a learned graph representation of a road network based on a node embedding of the node features and an edge embedding of the edge;
determine at least one hidden states value based on a graph convolution of the learned graph representation through the at least one encoder neural network; and
predict road traffic speed based on the at least one hidden states value through at least one decoder neural network.

20. (canceled)
